(19) United States
(12) Patent Application Publication
(10) Pub. No.: US 2021/0186795 A1
(43) Pub. Date: Jun. 24, 2021

(54) CERVICAL SPINE TRACTION DEVICE, EQUIPMENT AND METHOD

(71) Applicant: National Taipei University of Technology, Taipei City (TW)

(72) Inventors: HO CHANG, New Taipei City (TW); WEI LEE LI, New Taipei City (TW)

(21) Appl. No.: 16/720,256

(22) Filed: Dec. 19, 2019

(51) Int. Cl. A61H 1/02; A47G 9/10

(52) U.S. Cl. CPC A61H 1/0296; A47G 9/1081; A47G 9/1036; A61H 2201/02; A61H 2201/5007; A61H 2201/1607; A61H 2230/80; A61H 2205/04

(57) ABSTRACT

The present disclosure relates to a cervical spine traction device, equipment and method, wherein a built-in program code determines a cervical spine stretching force according to a sensed weight of a user. The cervical spine traction device has a main controller, a fixing unit, a movable unit and thermal massage units. By storing the program code in the main controller, the optimal traction data comprising a cervical spine stretching distance, the cervical spine stretching force and a cervical spine stretching time can be calculated according to the weight and height of the user lying down on the platform. Further, by sensing the temperature of the neck of the user and massaging the neck, the tension force of the neck muscle can be relaxed, the tightness of the user can be sufficiently eliminated, and the cervical spine of the user is corrected.

### BACKGROUND

### Technical Field

The present disclosure relates to a cervical spine traction device, equipment and method, and in particular, to a cervical spine traction device, equipment and method, which built-in program code can determine a traction data according a sensed weight of a user.

### Related Art

In a busy and tense modern society, the tempo with which people work and live is fast, so that the pressure is increasing, and the time to relax is less. Thus, the proportion which the patients have degenerative diseases or injuries in cervical spines is higher. The patients having degenerative diseases or injuries in cervical spines usually work the desk for a long time, and their cervical spines maintains a in a specific state for a long time, which causes the neck muscles to be in a non-coordinated stress state for a long time, such that the muscles and ligaments in the back of the neck may be damaged or degenerative.

The traction can be used for rehabilitation of all joints of the human body, and most of the clinical spine tractions are cervical and lumbar spine rehabilitations. The traction utilizes an external force to pull the joint apart, and the traction is not only effective to the joint, but also helpful to relax tight muscles, tendons or ligaments. Because, these discomforts are often caused by the compression of nerve roots, and the tractions are performed to stretch the nerve roots, which can eliminate pain and improve joints. However, traditional traction devices use multiple steps to measure and calculate corrected stretching forces, and it is not only tedious and time-consuming, but also not economical. Therefore, to achieve objectives of fast operation and high precision, how to use an innovative hardware design to effectively achieve the measurement through a one-time device and to provide the required corrected stretching force and time is still an important issue which the relevant industry developers and rehabilitation researchers work hard to overcome.

### SUMMARY

The main objective of the present disclosure is to provide a cervical spine traction device, equipment and method, which have a built-in program code to determine a cervical spine stretching force according to a sensed weight of a user. By storing the program code in a main controller, the optimal traction data comprising a cervical spine stretching distance, the cervical spine stretching force and a cervical spine stretching time can be calculated according to the weight and height of the user lying down on the platform. Further, by sensing the temperature of the neck of the user and massaging the neck, the tension force of the neck muscle can be relaxed, the tightness of the user can be sufficiently eliminated, and the cervical spine of the user is corrected.

To achieve the above objective of the present disclosure, the provided cervical spine traction device at least comprises a main controller, a fixing unit, a movable unit and thermal massage units. The main controller comprises an operation panel and a fixing base disposed on a top end of the main controller, wherein the fixing base has a pulley disposed therein, and the main controller controls the pulley to rotate. The fixing unit comprises two supports, a slide rail and a cord, wherein two ends of the support are respectively connected to the fixing base and the slide rail, and one end of the cord is connected to the pulley. The movable unit comprises a slide block, a headrest and two neck pillows, the slide block is disposed on another end of the cord, which is opposite to the pulley, the headrest is disposed on the slide block, and the two neck pillows are disposed on two opposite ends of the headrest, wherein the slide block is correspondingly disposed on the slide rail, and thus the slide block is able to move back and forth on the slide rail. The thermal massage unit is disposed in the neck pillow.

According to the cervical spine traction device, wherein the main controller stores a program code therein.

According to the cervical spine traction device, wherein the operation panel further comprises an input module.

According to the cervical spine traction device, wherein a bottom end of the main controller has a leg part for supporting the main controller.

According to the cervical spine traction device, wherein via a pivot, the supports are pivotally disposed on two ends of the fixing base respectively.

According to the cervical spine traction device, wherein two ends of the slide rail are disposed on the supports respectively.

According to the cervical spine traction device, wherein the slide rail is connected to the ends of the supports, which are opposite to the fixing base.

According to the cervical spine traction device, wherein the cord is connected to the slide block via a shackle.

According to the cervical spine traction device, wherein the slide block is disposed on the slide rail via a fixing block.

According to the cervical spine traction device, wherein two ends of the headrest have two fixing belts respectively.

According to the cervical spine traction device, wherein the neck pillows are connected to each other via a screw stem.

According to the cervical spine traction device, wherein two ends of the screw stem have knobs respectively.

Further, to achieve the above objective of the present disclosure, a cervical spine traction equipment is provided, and it at least comprises a platform and one of the above cervical spine tractions. The platform comprises a frame, a lying portion and a weight sensing unit, wherein the lying portion is disposed on the frame, and the weight sensing unit is embedded in the lying portion. One end of the slide rail, which is opposite to the support, is disposed on the lying portion.

According to the cervical spine traction equipment, wherein the platform further comprises a display module electrically connected to the weight sensing unit, and the display module displays a weight of the user, which is sensed by the weight sensing unit.

Further, to achieve the above objective of the present disclosure, a cervical spine traction method is provided. Firstly, store a program code in a main controller. Next, let a user to lie down on a lying portion of a platform, wherein the platform comprises a frame, the lying portion and a weight sensing unit, wherein the weight sensing unit is embedded in the lying portion to sense a weight of the user. Then, input the weight of the user, which is sensed by the weight sensing unit, and a height of the user into the main controller, such that the program code calculates a traction data of a cervical spine traction device. Finally, utilizes the cervical spine traction device to perform a cervical spine traction on the user, and at the same time, utilizes thermal massage units to heat and massage a cervical spine of the user.

According to the cervical spine traction method, wherein the traction data comprises a cervical spine stretching distance, a cervical spine stretching force and a cervical spine stretching time.

Accordingly, the cervical spine traction device, equipment and method mainly utilizes the program code built in the main controller to calculate the optimal traction data according to the weight and height of the user lying down on the platform, wherein the traction data comprises the cervical spine stretching force, distance and time. Further, by sensing the temperature of the neck of the user and massaging the neck, the tension force of the neck muscle can be relaxed, the tightness of the user can be sufficiently eliminated, and the cervical spine of the user is corrected.

### DESCRIPTIONS OF DRAWINGS

FIG. 1 is a schematic diagram showing a whole structure of a cervical spine traction device according to one embodiment of the present disclosure.

FIG. 2 is a schematic enlarged diagram showing a movable unit of a cervical spine traction device according to one embodiment of the present disclosure.

FIG. 3 is a schematic diagram showing an operation of neck pillows of a cervical spine traction device according to one embodiment of the present disclosure.

FIG. 4 is a schematic diagram showing an operation of a cervical spine traction device according to one embodiment of the present disclosure.

FIG. 5 is another one schematic diagram showing an operation of a cervical spine traction device according to one embodiment of the present disclosure.

FIG. 6 is a schematic diagram showing a whole structure of a cervical spine traction device according to another one embodiment of the present disclosure.

FIG. 7 is a schematic enlarged diagram showing a movable unit of a cervical spine traction device according to another one embodiment of the present disclosure.

FIG. 8 is a schematic diagram showing an operation of a cervical spine traction device according to another one embodiment of the present disclosure.

FIG. 9 is another one schematic diagram showing an operation of a cervical spine traction device according to another one embodiment of the present disclosure.

FIG. 10 is a schematic diagram showing a whole structure of a cervical spine traction equipment according to one embodiment of the present disclosure.

FIG. 11 is a schematic diagram showing a whole structure of a cervical spine traction equipment according to another one embodiment of the present disclosure.

FIG. 12 is a schematic diagram showing an operation of a cervical spine traction equipment according to one embodiment of the present disclosure.

FIG. 13 is a flow chart showing a cervical spine traction method according to one embodiment of the present disclosure.

### DESCRIPTIONS AND DETAILS OF EMBODIMENTS

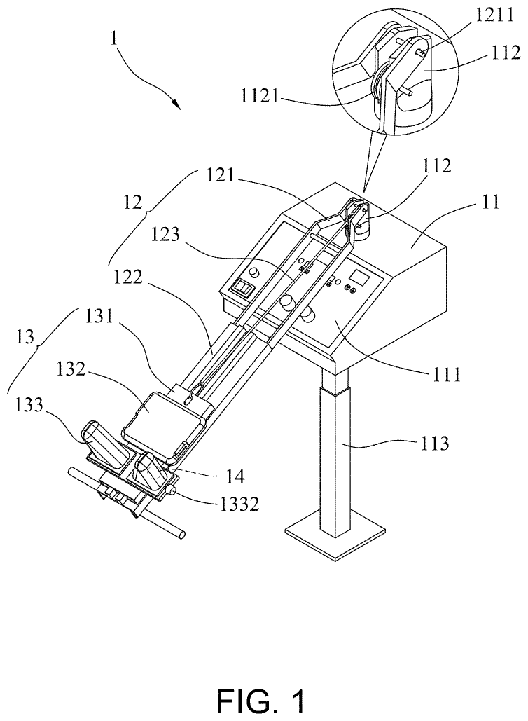

In the present disclosure, the cervical spine traction device, equipment and method mainly utilizes the program code built in the main controller (11) to calculate the optimal traction data according to the weight and height of the user (3) lying down on the platform (2), wherein the traction data comprises the cervical spine stretching force, distance and time. Further, by sensing the temperature of the neck of the user (3) and massaging the neck, the tension force of the neck muscle can be relaxed, the tightness of the user (3) can be sufficiently eliminated, and the cervical spine of the user (3) is corrected. Firstly, referring to FIG. 1, FIG. 1 is a schematic diagram showing a whole structure of a cervical spine traction device according to one embodiment of the present disclosure, and the cervical spine traction device (1) at least comprises a main controller (11), a fixing unit (12), a movable unit (13) and thermal massage units (14).

The main controller (11) at least comprises an operation panel (111), a fixing base (112) and a leg part (113). The fixing base (112) is disposed on a top end of the main controller (11), and the leg part (113) is disposed on a bottom end of the main controller (11) for supporting the main controller (11), wherein the main controller (11) has a program code (not shown in drawings) built or stored therein, and the operation panel (111) further comprises an input module (not shown in drawings). The operation panel (111) and the input module allows a user to input his or other user's weight and height into the program code, and the program code accordingly calculates the traction data which the cervical spine traction device (1) must provide to the user, wherein the traction data comprises a cervical spine stretching distance, a cervical spine stretching force and a cervical spine stretching time, which are used to stretch the cervical spine of the user. Further, as shown in the enlarged view at top right part of FIG. 1, the fixing base (112) has a pulley (1121) therein, and the main controller (11) is configured to control the pulley (1121) to rotate.

The fixing unit (12) at least comprises two supports (121), a slide rail (122) and a cord (123), wherein two ends of each of the supports (121) are respectively connected to the fixing base (112) and the slide rail (122), and as shown in the enlarged view at top right part of FIG. 1, two ends of the supports (121) are pivotally connected to two ends of the fixing base (112) via a pivot (1211). Further, two ends of the slide rail (122) are disposed on the supports (121), such that slide rail (122) can move back and forth on the support (121). Further, one end of the cord (123) is connected to the pulley (1121).

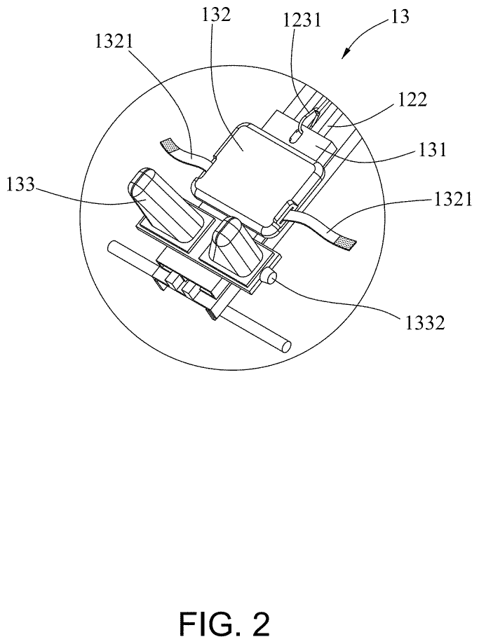

The movable unit (13) at least comprises a slide block (131), a headrest (132) and two neck pillows (133). The slide block (131) is disposed on another one end of the cord (123), which is opposite to the pulley (1121), and the cord (123) is connected to the slide block (131) via a shackle (1231) (as shown in FIG. 2). The headrest (132) is disposed on a top end of the slide block (131), and the neck pillows (133) are disposed on two opposite ends of the headrest (132). Further, the slide block (131) is disposed on the slide rail (122). In addition to that the slide rail (122) can move back and forth on the supports (121), the slide block (131) can also move back and forth on the slide rail (122). Moreover, two ends of the headrest (132) respectively have two fixing belts (1321), which are used to fix the head of the user. The neck pillows (133) can be connected to each other via a screw stem (1331), and two ends of the screw stem (1331) respectively have two knobs (1332), wherein when rotating the knobs (1332), the neck pillows (133) are driven to displace on the screw stem (1331), and thus the relative positions of the neck pillows (133) can be changed, i.e. the distance between of the two neck pillows (133) can be adjusted.

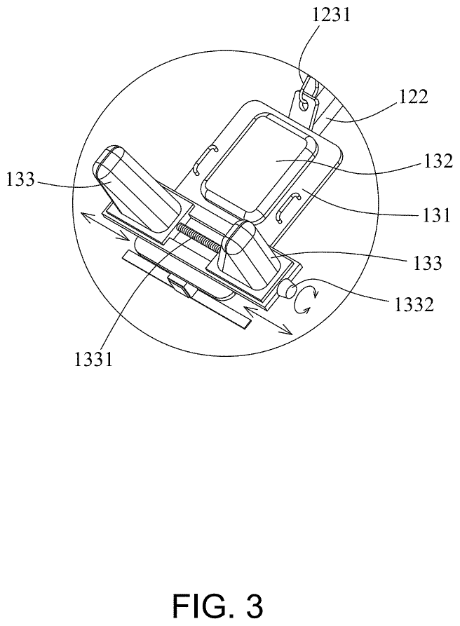

Referring to FIG. 2 and FIG. 3, FIG. 2 is a schematic enlarged diagram showing a movable unit of a cervical spine traction device according to one embodiment of the present disclosure, and FIG. 3 is a schematic diagram showing an operation of neck pillows of a cervical spine traction device according to one embodiment of the present disclosure. The headrest (132) is provided to the head of the user lying down, and the fixing belts (1321) on the two ends of the headrest (132) are used to tie and fix the head of the user. The neck of the user contacts the middle location of the neck pillows (133), the neck pillows (133) are connected to each other via the screw stem (1331), and the two ends of the screw stem (1331) have the two knobs (1332), such that the user can increase or reduce the distance between of the two neck pillows (133) according to his or other user's neck width.

The thermal massage units (14) are disposed in the neck pillows (133), and the thermal massage unit (14) can sense the temperature of the neck of the user and heat the neck via the neck pillow (133), and further can massage the neck.

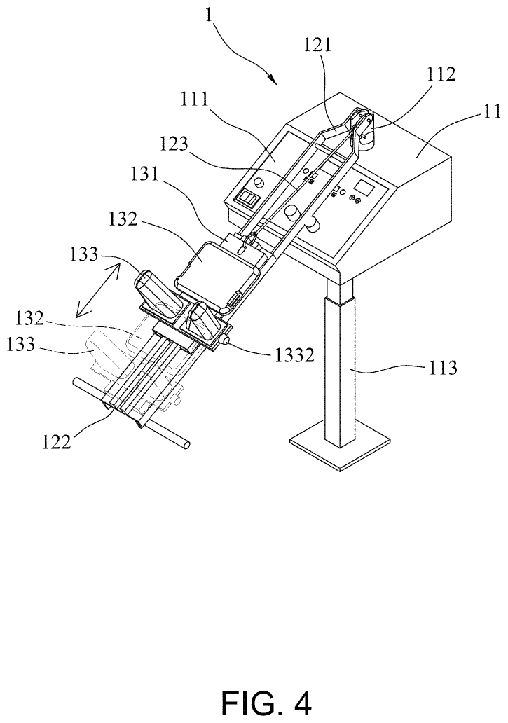

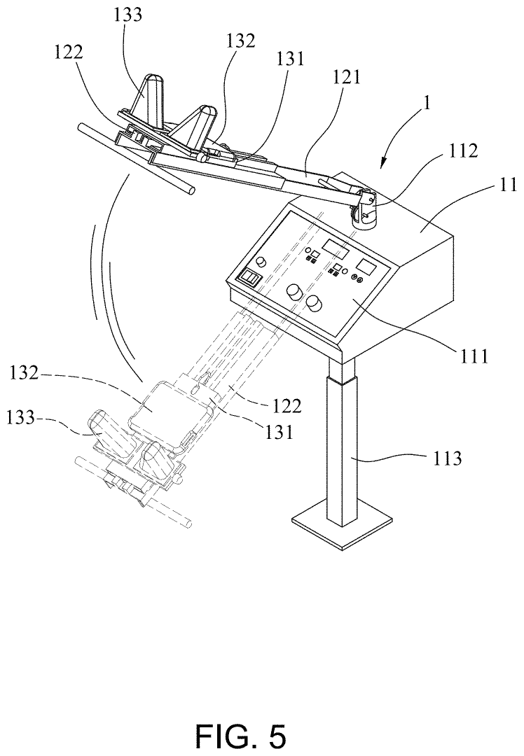

Referring to FIG. 4 and FIG. 5, FIG. 4 is a schematic diagram showing an operation of a cervical spine traction device according to one embodiment of the present disclosure, and FIG. 5 is another one schematic diagram showing an operation of a cervical spine traction device according to one embodiment of the present disclosure. When the head of the user is put on the headrest (132) and the neck of the user contacts the middle position of the neck pillows (133), the user or other user can input the weight and height of the user via the input module, and the program code can calculate a traction data of the cervical spine traction device (1), which comprises the cervical spine stretching distance, the cervical spine stretching force and the cervical spine stretching time. After the traction data has been calculated, the main controller (11) starts to control the pulley (1121) to rotate, and the pulley (1121) can drive the headrest (132) and neck pillows (133) to move on the slide rail (122) and to the position of the pulley (1121) by using the cord (123) to drive the slide block (131), such that the cervical spine of the user is stretched (as shown in FIG. 4). Further, fixing base (112) can move the supports (121) upward via the pivot (1211), and thus the whole fixing unit (12) and movable unit (13) can be driven to move upward, so as to stretch the cervical spine of the user (as shown in FIG. 5).

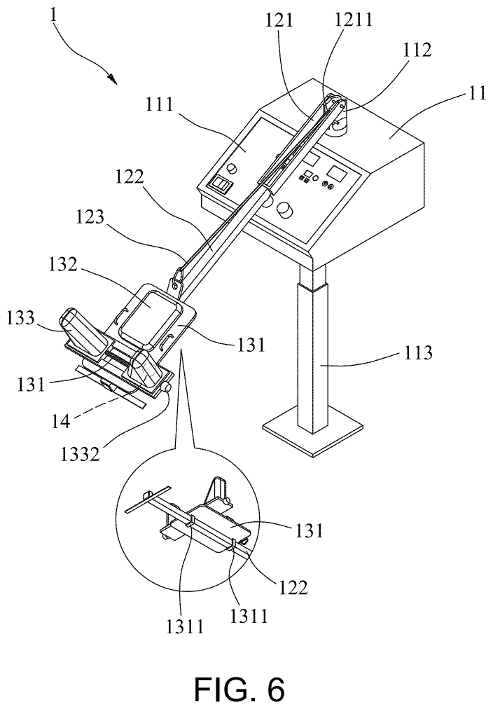

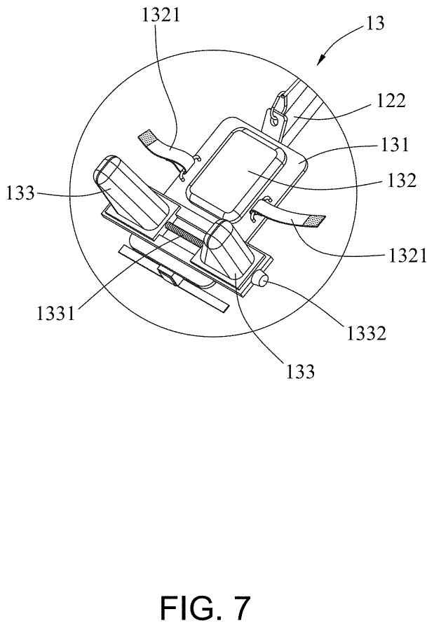

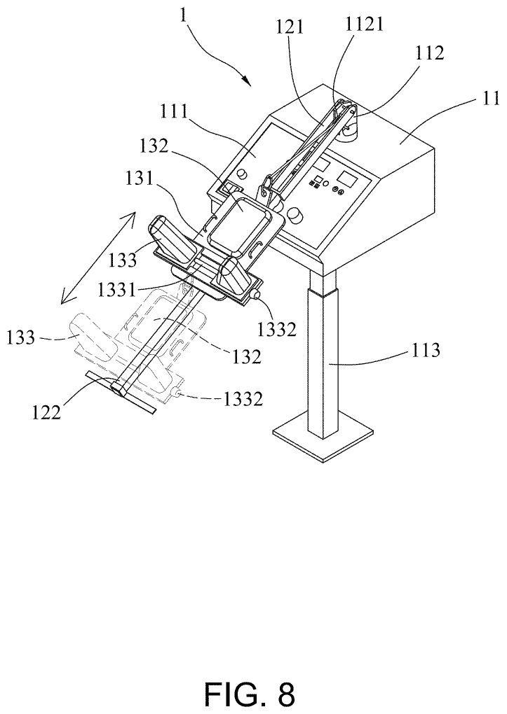

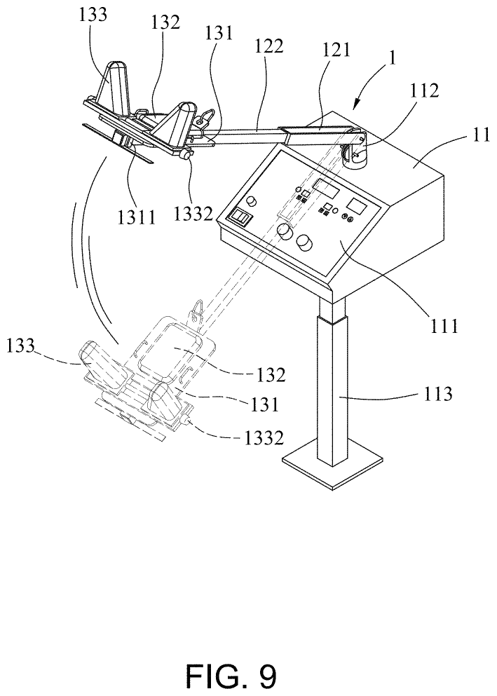

Referring to FIG. 6 through FIG. 9, FIG. 6 is a schematic diagram showing a whole structure of a cervical spine traction device according to another one embodiment of the present disclosure, FIG. 7 is a schematic enlarged diagram showing a movable unit of a cervical spine traction device according to another one embodiment of the present disclosure, FIG. 8 is a schematic diagram showing an operation of a cervical spine traction device according to another one embodiment of the present disclosure, and FIG. 9 is another one schematic diagram showing an operation of a cervical spine traction device according to another one embodiment of the present disclosure. The fixing unit (12) and the movable unit (13) of the cervical spine traction device (1) in the embodiment is different from those in the above embodiment, wherein in the embodiment, the slide rail (122) is connected to the ends of the supports (121), which are opposite to the fixing base (112), and the slide block (131) is disposed on the slide rail (122) via at least one fixing block (1311). When the head of the user is put on the headrest (132) and the neck of the user contacts the middle position of the neck pillows (133), the user or other user can input the weight and height of the user via the input module, and the program code can calculate a traction data of the cervical spine traction device (1), which comprises the cervical spine stretching distance, the cervical spine stretching force and the cervical spine stretching time. After the traction data has been calculated, the main controller (11) starts to control the pulley (1121) to rotate, and the pulley (1121) can drive the headrest (132) and neck pillows (133) to move on the slide rail (122) and to the position of the pulley (1121) by using the cord (123) to drive the slide block (131), such that the cervical spine of the user is stretched (as shown in FIG. 8). Further, fixing base (112) can move the supports (121) upward via the pivot (1211), and thus the whole fixing unit (12) and movable unit (13) can be driven to move upward, so as to stretch the cervical spine of the user (as shown in FIG. 9).

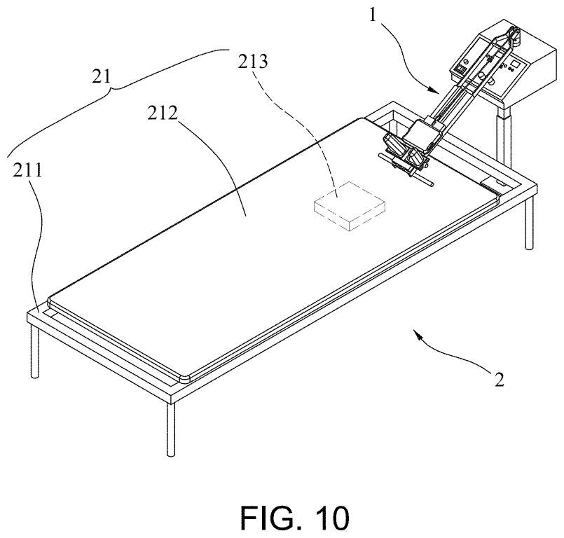

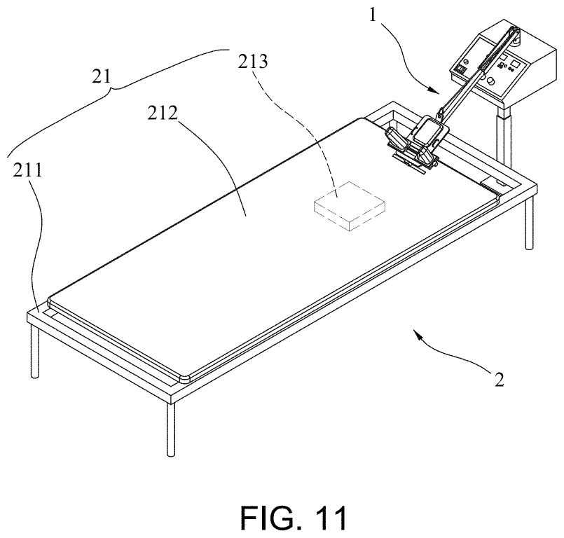

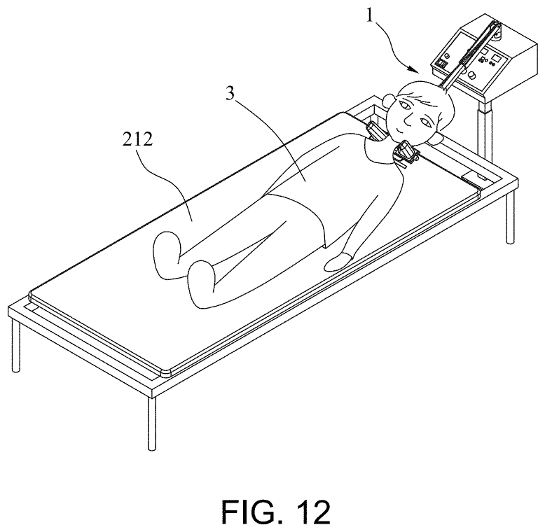

Next, referring to FIG. 10 through FIG. 12, FIG. 10 is a schematic diagram showing a whole structure of a cervical spine traction equipment according to one embodiment of the present disclosure, FIG. 11 is a schematic diagram showing a whole structure of a cervical spine traction equipment according to another one embodiment of the present disclosure, and FIG. 12 is a schematic diagram showing an operation of a cervical spine traction equipment according to one embodiment of the present disclosure. The cervical spine traction equipment (2) at least comprises a platform (21) and one of the above cervical spine traction devices (1).

The platform (21) at least comprises a frame (211), a lying portion (212) and a weight sensing unit (213), wherein the lying portion (212) is disposed on the frame (211), the frame (211) can be a bed frame but the present disclosure is not limited thereto, the weight sensing unit (213) is embedded in the bed of the lying portion (212), which is used to sense the weight of the user (3) lying down on the lying portion (212), and the weight sensing unit (213) can be a weight meter but the present disclosure is not limited thereto. The platform (21) further comprises a display module (not shown in drawings) electrically connected to the weight sensing unit (213), and the display module displays a weight of the user (3), which is sensed by the weight sensing unit (213).

One end of the slide rail (122), which is opposite to the support (121), is disposed on the lying portion (212). That is, in the cervical spine traction device (1) of FIG. 10 or FIG. 11, one end of the slide rail (122) of the fixing unit (12), which is opposite to the support (121), is disposed on the lying portion (212). When the user (3) lying down on the lying portion (212), the head of the user is put on the headrest (132) and the neck of the user contacts the middle position of the neck pillows (133), the weight sensing unit (213) embedded in the lying portion (212) can sense the weight of the user (3), another user can input the weight and height of the user via the input module into the program code built in the main controller, the program code can calculate a traction data of the cervical spine traction device (1), which comprises the cervical spine stretching distance, the cervical spine stretching force and the cervical spine stretching time. After the traction data has been calculated, the main controller (11) starts to control the pulley (1121) to rotate, and the pulley (1121) can drive the headrest (132) and neck pillows (133) to move on the slide rail (122) and to the position of the pulley (1121) by using the cord (123) to drive the slide block (131), such that the cervical spine of the user is stretched.

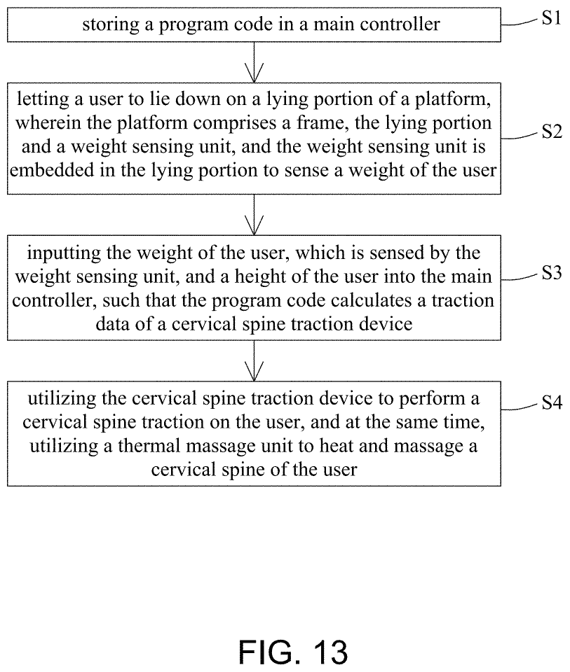

Further, referring to FIG. 13, FIG. 13 is a flow chart showing a cervical spine traction method according to one embodiment of the present disclosure. The cervical spine traction method comprises at least steps as follows.

At a first step (S1), store a program code in a main controller (11). Referring to FIG. 1 and FIG. 10, the main controller (11) at least comprises an operation panel (111), a fixing base (112) and a leg part (113). The fixing base (112) is disposed on a top end of the main controller (11), and the leg part (113) is disposed on a bottom end of the main controller (11) for supporting the main controller (11), wherein the main controller (11) has a program code (not shown in drawings) built or stored therein, and the operation panel (111) further comprises an input module. The operation panel (111) and the input module allows a user to input his or other user's weight and height into the program code, and the program code accordingly calculates the traction data which the cervical spine traction device (1) must provide to the user, wherein the traction data comprises a cervical spine stretching distance, a cervical spine stretching force and a cervical spine stretching time, which are used to stretch the cervical spine of the user. The fixing base (112) has a pulley (1121) therein, and the main controller (11) is configured to control the pulley (1121) to rotate.

At a second step (S2), let a user (3) to lie down on a lying portion of a lying portion (212) of a platform (21), wherein the platform (21) comprises a frame (211), the lying portion (212) and a weight sensing unit (213). the lying portion (212) is disposed on the frame (211), the frame (211) can be a bed frame but the present disclosure is not limited thereto, the weight sensing unit (213) is embedded in the bed of the lying portion (212), which is used to sense the weight of the user (3) lying down on the lying portion (212), and the weight sensing unit (213) can be a weight meter but the present disclosure is not limited thereto. The platform (21) further comprises a display module (not shown in drawings) electrically connected to the weight sensing unit (213), and the display module displays a weight of the user (3), which is sensed by the weight sensing unit (213).

At a third step (S3), input the weight of the user (3), which is sensed by the weight sensing unit (213), and a height of the user (213) into the main controller (11), such that the program code calculates a traction data of a cervical spine traction device (1), wherein the traction data comprises a cervical spine stretching distance, a cervical spine stretching force and a cervical spine stretching time.

At a fourth step (S4), utilizes the cervical spine traction device (1) to perform a cervical spine traction on the user (3), and at the same time, utilizes thermal massage units (14) to heat and massage a cervical spine of the user (3). When the user (3) lying down on the lying portion (212), the head of the user is put on the headrest (132) and the neck of the user contacts the middle position of the neck pillows (133), the weight sensing unit (213) embedded in the lying portion (212) can sense the weight of the user (3), another user can input the weight and height of the user via the input module into the program code built in the main controller, the program code can calculate a traction data of the cervical spine traction device (1), which comprises the cervical spine stretching distance, the cervical spine stretching force and the cervical spine stretching time. After the traction data has been calculated, the main controller (11) starts to control the pulley (1121) to rotate, and the pulley (1121) can drive the headrest (132) and neck pillows (133) to move on the slide rail (122) and to the position of the pulley (1121) by using the cord (123) to drive the slide block (131), such that the cervical spine of the user is stretched. Further, the thermal massage units (14) disposed in the neck pillows (133) can heat and massage the neck of the user (3) via the neck pillows (133).

From the descriptions of the above embodiment, compared to the prior art, the cervical spine traction device, equipment and method have the following advantages.

The cervical spine traction device, equipment and method mainly utilizes the program code built in the main controller to calculate the optimal traction data according to the weight and height of the user lying down on the platform, wherein the traction data comprises the cervical spine stretching force, distance and time. Further, by sensing the temperature of the neck of the user and massaging the neck, the tension force of the neck muscle can be relaxed, the tightness of the user can be sufficiently eliminated, and the cervical spine of the user is corrected.

What is claimed is:

1. A cervical spine traction device, at least comprising:
a main controller, comprising an operation panel and a fixing base disposed on a top end of the main controller, wherein the fixing base has a pulley disposed therein, and the main controller controls the pulley to rotate;
a fixing unit, comprising two supports, a slide rail and a cord, wherein two ends of the support are respectively connected to the fixing base and the slide rail, and one end of the cord is connected to the pulley;
a movable unit, comprising a slide block, a headrest and two neck pillows, the slide block is disposed on another end of the cord, which is opposite to the pulley, the headrest is disposed on the slide block, and the two neck pillows are disposed on two opposite ends of the headrest, wherein the slide block is correspondingly disposed on the slide rail, and thus the slide block is able to move back and forth on the slide rail; and
thermal massage units, each disposed in the neck pillow.

2. The cervical spine traction device according to claim 1, wherein the main controller stores a program code therein.

3. The cervical spine traction device according to claim 1, wherein the operation panel further comprises an input module.

4. The cervical spine traction device according to claim 1, wherein a bottom end of the main controller has a leg part for supporting the main controller.

5. The cervical spine traction device according to claim 1, wherein via a pivot, the supports are pivotally disposed on two ends of the fixing base respectively.

6. The cervical spine traction device according to claim 1, wherein two ends of the slide rail are disposed on the supports respectively.

7. The cervical spine traction device according to claim 1, wherein the slide rail is connected to the ends of the supports, which are opposite to the fixing base.

8. The cervical spine traction device according to claim 1, wherein the cord is connected to the slide block via a shackle.

9. The cervical spine traction device according to claim 1, wherein the slide block is disposed on the slide rail via a fixing block.

10. The cervical spine traction device according to claim 1, wherein two ends of the headrest have two fixing belts respectively.

11. The cervical spine traction device according to claim 1, wherein the neck pillows are connected to each other via a screw stem.

12. The cervical spine traction device according to claim 1, wherein two ends of the screw stem have knobs respectively.

13. A cervical spine traction equipment, at least comprising:
a platform, comprising a frame, a lying portion and a weight sensing unit, wherein the lying portion is disposed on the frame, and the weight sensing unit is embedded in the lying portion; and
a cervical spine traction device, at least comprising:
a main controller, comprising an operation panel and a fixing base disposed on a top end of the main controller, wherein the fixing base has a pulley disposed therein, and the main controller controls the pulley to rotate;
a fixing unit, comprising two supports, a slide rail and a cord, wherein two ends of the support are respectively connected to the fixing base and the slide rail, and one end of the cord is connected to the pulley;
a movable unit, comprising a slide block, a headrest and two neck pillows, the slide block is disposed on another end of the cord, which is opposite to the pulley, the headrest is disposed on the slide block, and the two neck pillows are disposed on two opposite ends of the headrest, wherein the slide block is correspondingly disposed on the slide rail, and thus the slide block is able to move back and forth on the slide rail; and
thermal massage units, each disposed in the neck pillow;
wherein one end of the slide rail, which is opposite to the support, is disposed on the lying portion.

14. The cervical spine traction equipment according to claim 13, wherein the platform further comprises a display module electrically connected to the weight sensing unit, and the display module displays a weight of the user, which is sensed by the weight sensing unit.

15. A cervical spine traction method, at least comprising:
storing a program code in a main controller;
letting a user to lie down on a lying portion of a platform, wherein the platform comprises a frame, the lying portion and a weight sensing unit, and the weight sensing unit is embedded in the lying portion to sense a weight of the user;
inputting the weight of the user, which is sensed by the weight sensing unit, and a height of the user into the main controller, such that the program code calculates a traction data of a cervical spine traction device; and
utilizing the cervical spine traction device to perform a cervical spine traction on the user, and at the same time, utilizing thermal massage units to heat and massage a cervical spine of the user.

16. The cervical spine traction method according to claim 15, wherein the traction data comprises a cervical spine stretching distance, a cervical spine stretching force and a cervical spine stretching time.
